(19) United States
(12) Patent Application Publication
(10) Pub. No.: US 2022/0211095 A1
(43) Pub. Date: Jul. 7, 2022

(54) WEIGH STATION WITH A LINEAR VIBRATING FUNNEL AND A LINEAR VIBRATING, TAPPING MECHANISM TO PACK AN ARTICLE INTO A TAPERED CONE USING FRICTIONLESS MAGNETIC LEVITATION

(71) Applicant: John Timothy Sullivan, Marriottsville, MD (US)

(72) Inventor: John Timothy Sullivan, Marriottsville, MD (US)

(21) Appl. No.: 17/581,055

(22) Filed: Jan. 21, 2022

Related U.S. Application Data
(63) Continuation-in-part of application No. 16/856,271, filed on Apr. 23, 2020.
(60) Provisional application No. 62/922,056, filed on Jul. 23, 2019.
(60) Provisional application No. 62/995,884, filed on Feb. 19, 2020.

(51) Int. Cl. A24C 5/39; G01G 17/04; A24C 5/34

(52) U.S. Cl. CPC A24C 5/395; G01G 17/04; A24C 5/399; A24C 5/3424; A24C 5/397; A24C 5/393

(57) ABSTRACT

A power ground oily flower such as cannabis or hemp is loaded into a tapered paper cone by using a linear vibrator having an eccentric drive bearing to focus the forces in the direction the powder was traveling. A linear piston is driven by an eccentric drive mechanism to tap the bottom of the cone with programmable frequencies to achieve the desired pack rates at high speeds. Eccentric actuators are also used to drive the power from the storage hopper to a linear vibrating feeder to a vibration bowl feeder to a weigh station that is dumped into a vibrating funnel that moved up and down with a lineal actuator to align the funnel to a paper cone with a receiving tapered tube to fill a cone with power that is being vibrated by a cone vibrator to pack the cone during filling.

This application claims the benefit of provisional U.S. Patent Appl. Ser. No. 63/361,413, filed Dec. 21, 2021, and incorporated by reference herein.

This application is a continuation-in-part of U.S. patent application Ser. No. 16/856,271, filed Apr. 23, 2020, also incorporated by reference herein, which claims the benefit of provisional U.S. Patent Appl. Ser. Nos. 62/922,056, filed Sep. 23, 2019, and 62/995,884, filed Feb. 19, 2020.

The present invention involved loading a power ground oily flower such as cannabis or hemp into a tapered paper cone. The difficulty with moving an oily power from point A to point B is the stickiness of the lose powder and static electric material that hold a capacitive charge it wants to stick to all surfaces. To overcome this problem, linear vibrator using eccentric drive bearing were used to focus the forces in the direction the powder was traveling. The problem with 3D vibrators the forces move in all directions that causes the produce to spiral down a funnel reducing the speed the powder travels through a funnel into the loading cone. Another problem to overcome is loading the powder into a smokable cone at a desired pack or density. The enclosed invention uses a novel linear piston drive by an eccentric drive mechanism to tap the bottom of the cone with programmable frequencies to achieve the desired pack rates at high speeds. By driving the single cone up and down in the cone holder and consistent pack rate was achieved. The novel invention used eccentric actuators to drive the power from the storage hopper to a linear vibrating feeder to a vibration bowl feeder to a weigh station that is dumped into a vibrating funnel that moved up and down with a lineal actuator to align the funned to a paper cone with a receiving tapered tube to fill a cone with power that is being vibrated by a cone vibrator to pack the cone during filling. One of the problems with a reciprocating motor-driven vibrator is the wear part with bearing operating at such a high rate of speeds. Piezoelectric vibrators can operate at high speeds but can not deliver the stroke needed to shake powers at high speeds into compaction. The enclosed invention improves the mechanical wear and tear with mechanical reciprocating shakers and the linear and rotating friction they produce with a high stroke pule by employing an electromagnetic levitating shaker that utilizes permanent magnetic suspended on three or more electromagnetic coils, permanent magnetic and or a radio frequency voice coil that works in synchronization using electromagnetic digital or analog pulse synchronization with the voice coil to driver the permanent magnetic in the same direction of the electromagnetic pulses. The invention levitating vibrator vibrated the cannabis or other products in a cone, bottle or bag to remove dust particles from a funnel to allow the product to travel through the funnel faster or it taps the bottom of a cone in FIG. 28,29,30 to improve production speeds. The cone can be pre-made of from a roll of cone paper. The cone loading can be made from a rotating stack or linear stack.

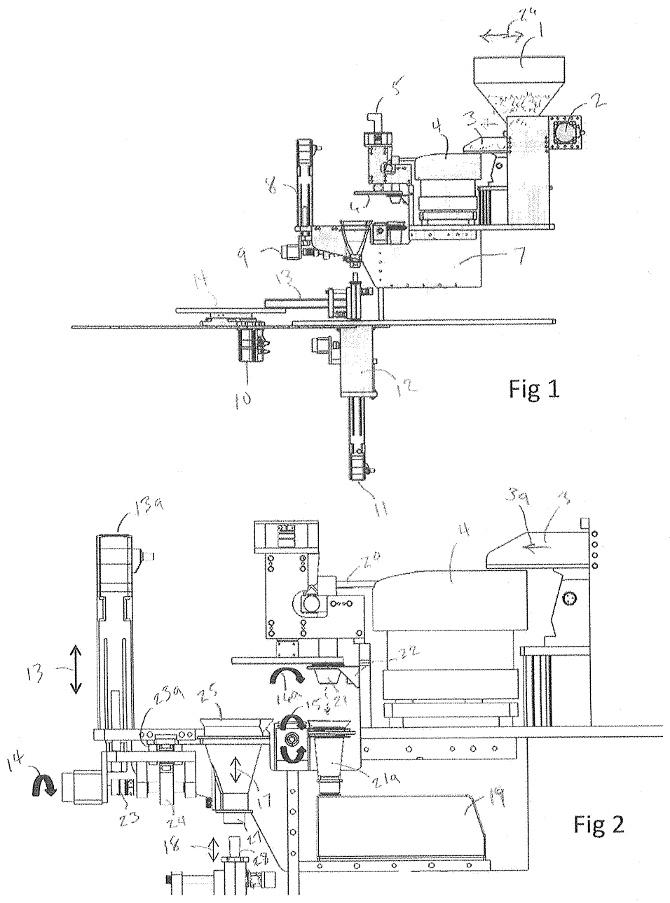

FIG. 1. Is a side transparent view of the filling, weighing and compacting cone loading station. The loading biomass bowl is 1 that travels on a linear bearing in the direction of 26 by motor 2. The linear vibrating feeder 3 conveys the powder into a bowl feeder 4 that uses a diverting rotary valve 6 driver my motor 5 that is weighed by a loadcell 7. The cone loading funnel is driver up and down by actuator 8 and the funnel is vibrated by motor 9. The cone is held in a rotating turret assemble 14 and rotated on a table 14 by motor 10. The cone when being filed with a powder is vibrated by the vibrator assemble 12 the drives the vibrator into the cone up and down by actuator 11.

FIG. 2 Is a side view of FIG. 1. The vibrator 3 moves the powder 3a into the bowl feeder 4 the transfer the power to a trough 20 that is controlled by a rotating valve 16a that passes through a funnel with a magnetic removable base. The weigh cup is 21a that rotates onto the load cell 19 that rotates in the direction of 15 up to 180 degrees to dump the weighed article into a vibration funnel with a linear up/down actuator 13,13a that vibrates with linear vibrator motor 14, coupler 23 that rotates an eccentric shaft bearing that rotate a yoke 24 to cause a linear motion on linear shaft bearings 23a. The funnel interface hub 27 is lowered onto a cone 28 before filling begins.

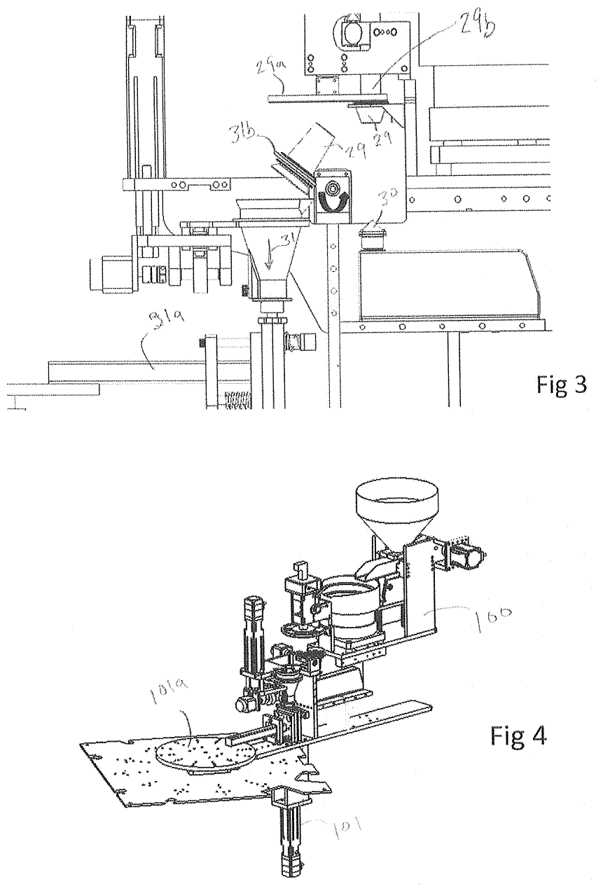

FIG. 3 is a side view of a weigh station and turret assemble. The weigh funnel is 29 the accumulation On/Off valve is 29a that stores bulk product in the fill tube 29a during funnel 29 discharge into the vibrating funnel. The powder falls with gravity in the direction of 31. The weigh base is a pointed cap to align the weight cup onto the center of the base so the cup is no longer in contact with the cup bracket 31b that has an oversize hole between two plates. The 31b bracket is assemble with two split halves to surround the round cup 29.

FIG. 4 Is a perspective assemble of a weigh station 100 with a vibrating linear 2D cone shaker 101 that raises and lowers to allow the turret 101a to rotate other turrets not shown.

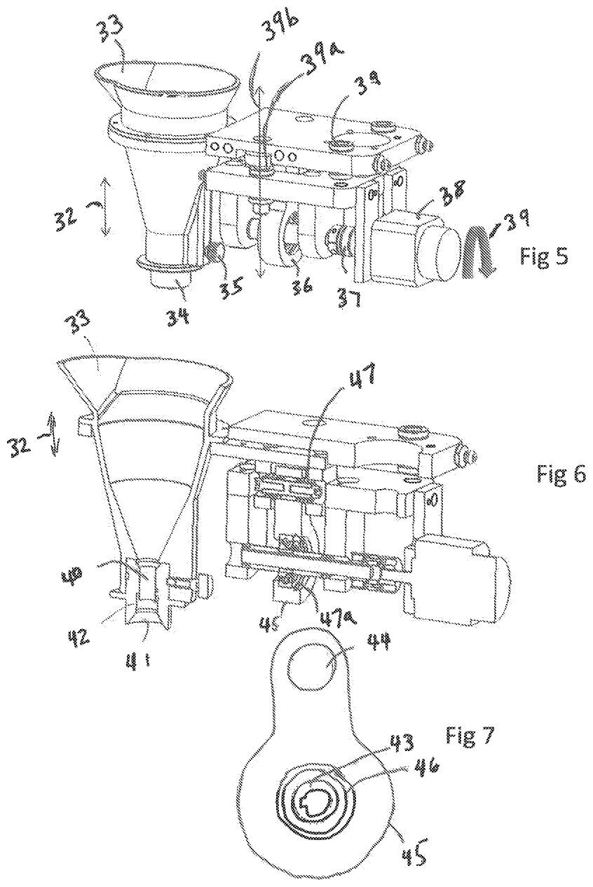

FIG. 5 is perspective view of a vibrating funnel assemble that travels up and down by rotating motor 38 that rotated shaft coupler 37 the rotates an eccentric shaft bushing not shown that causes a yoke 36 to travel up and down on linear shaft bearing 39a.

FIG. 6 is a cut away assemble of FIG. 5 the eccentric bearing holder 45 with yoke bearings 47a, 47 the causes the funnel 33 assemble shake up and down 32 with a motor-controlled frequency to shake powders out of the bottom of the funnel without sticking or clumping. The thumb screw or spring-loaded pin 35 allows the operator to change out interface bushing 41 tapered cone interfaces with a up and down paper cone vibrating zone 42 round side walls, the formed flared tube 40 nest into the paper cone not shown during powder filling cycles to prevent spilling.

FIG. 7 Is a side view of the yoke assemble for the funnel shaker in FIG. 5, fig, FIG. 10 and hopper shaker in FIG. 1. The eccentric bearing bushing is 43 the bearing is 46 the yoke is 25

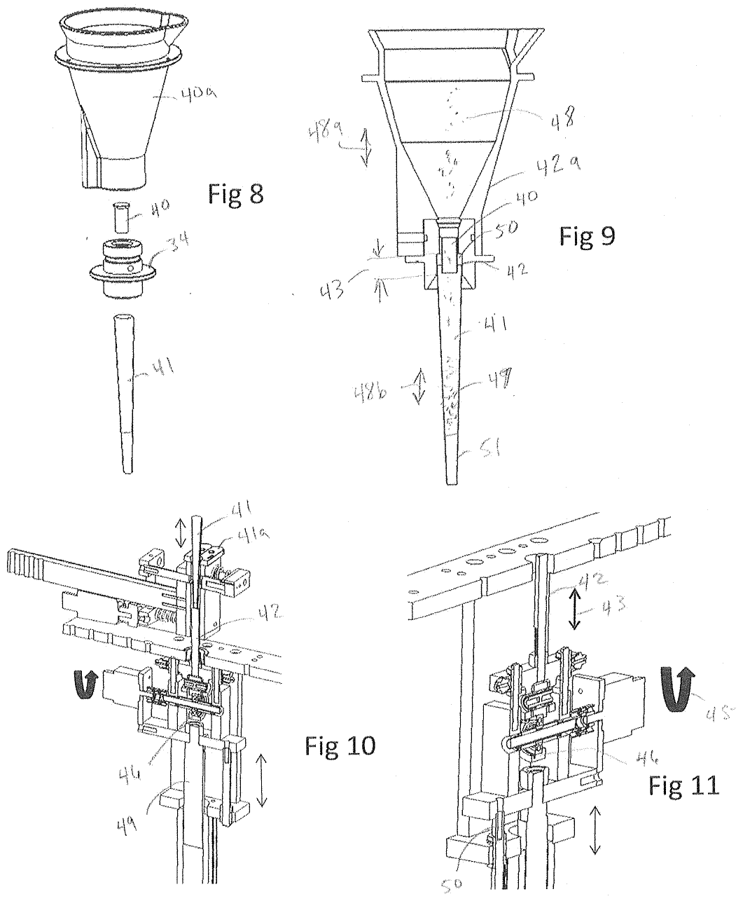

FIG. 8 is a vibrating funnel 40a assemble. The flared tube 40 that is moved into the cone 41 to prevent spillage the cone interface 34 moves with the vibrating funnel 40a.

FIG. 9 is a cut away view of a vibrating cone funnel 42a assembles and cone 41. The vibrating funnel is 42a the interface assemble is 42,40. The cone 41 has the tube 40 placed inside of the cone by the linear actuator not shown. The cone 41 vibrates up and down 48b by a vibrating piston shown in FIG. 10,11 in the vibrating zone 43 in the round tube withing the interface. The power material is 48,49 and cone filter is 51.

FIG. 10 is a cut away view of a cone shaker that uses an eccentric linear vibrator 46 and linear actuator 49 to vibrate a cone 41 during powder filling to vibrate the cone up and down in a cone holder assemble 41a to compact the powder in the cone at the desired frequency and time for a programmable compactness. The vibrating piston is 42 that makes contact with the hard filter on the bottom of the smokable cone.

FIG. 11 Is a cut away of FIG. 10. The eccentric bearing is 46 the up and down piston is 42 and travel is 43, the linear actuator is 50.

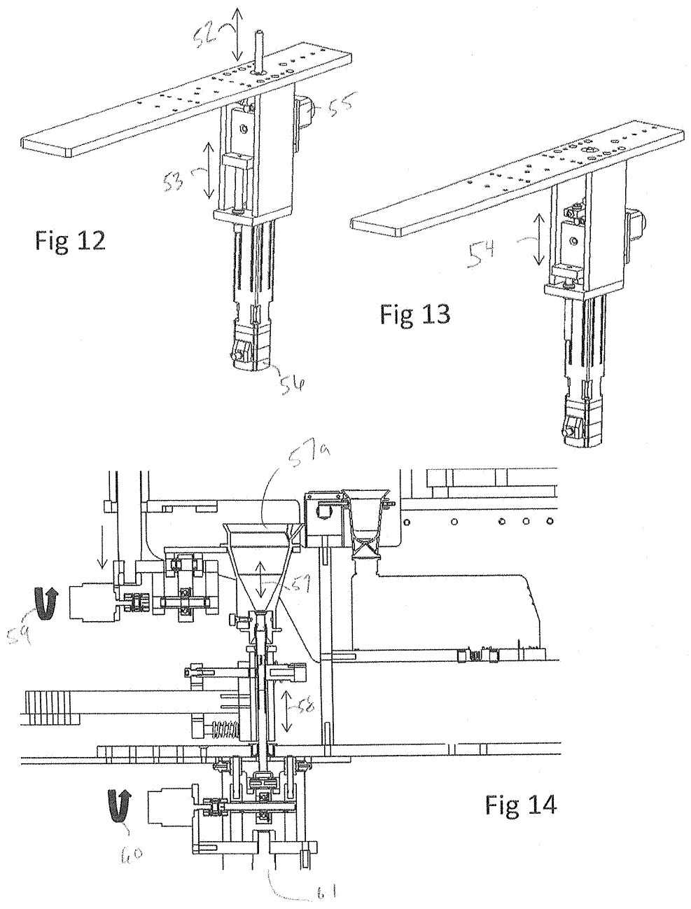

FIG. 12 is a perspective view of a cone shaker linear actuator 56. The eccentric motor assemble travel is 53 the piston travel is 52.

FIG. 13 is a perspective view of FIG. 12 in the down position 54 so the turret assembles not shown can rotate to the next twister station.

FIG. 14 Is a cut away side view of a weigh and filling station 59 is a rotating motor to vibrate the funnel 57a in the direction of 57 while the piston in FIG. 12 moves up and down to cause a linear vibration on the cone that is being filled in the assemble.

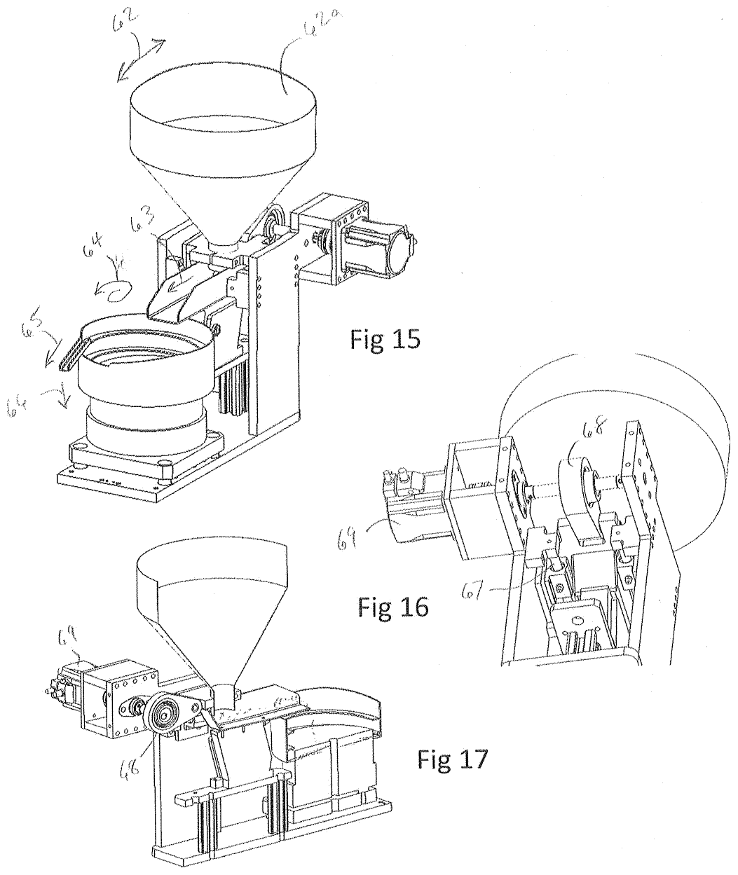

FIG. 15 Is a perspective view of a biomass bowl feeder shaker 62a and storage. The biomass inventory feeder vibrates linear in the direction of 62 using an eccentric that discharges out of the vibratory feeder 63 and then in the bowl feeder rotation 64 the discharges in the trough 65 down to the weight hopper not shown.

FIG. 16 is a bottom view of the linear vibratory feeder motor 69 and 67 linear eccentric yoke 68 and bearing assemble.

FIG. 17 is a cut away view of FIG. 15 the storage bowl motor is 69 and eccentric linear vibrator yoke 68.

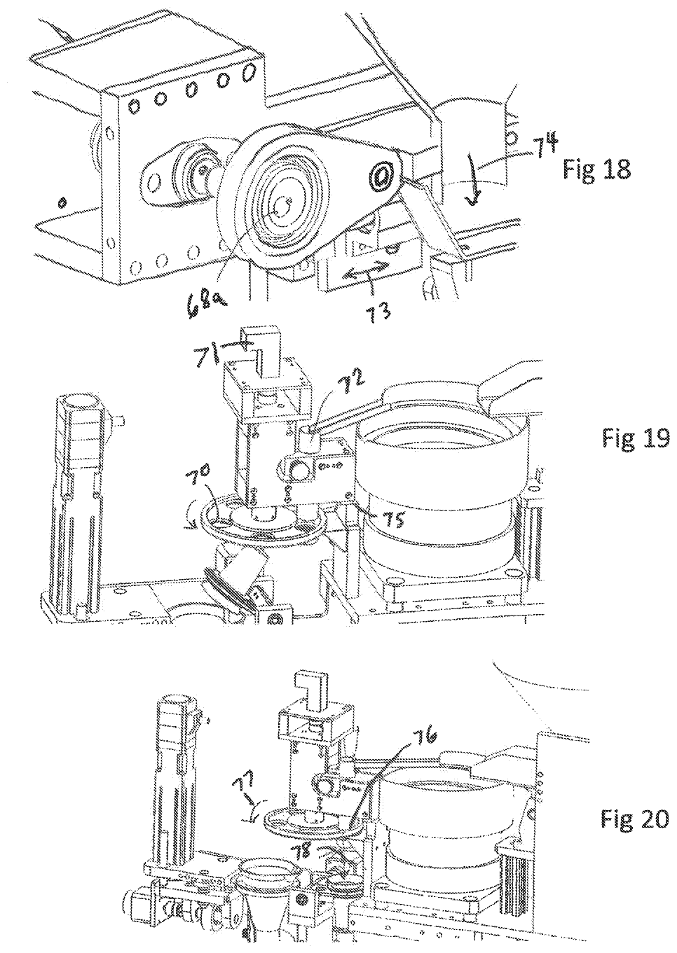

FIG. 18 Is a cut away view of FIG. 15 with the eccentric bearing bushing 68a linear motion 73 on the linear slide bearings.

FIG. 19 Is a perspective view of the rotary filling station with an accumulation revivor 72. The rotary valve motor 71 the valve on/off opening 70. The accumulation tube is acquiring powder while the weighed cup is dumping product into the cone station.

FIG. 20 the vale is in the open position dumping the accumulation into the weigh cup and trickling the final weigh with higher accuracies of weight.

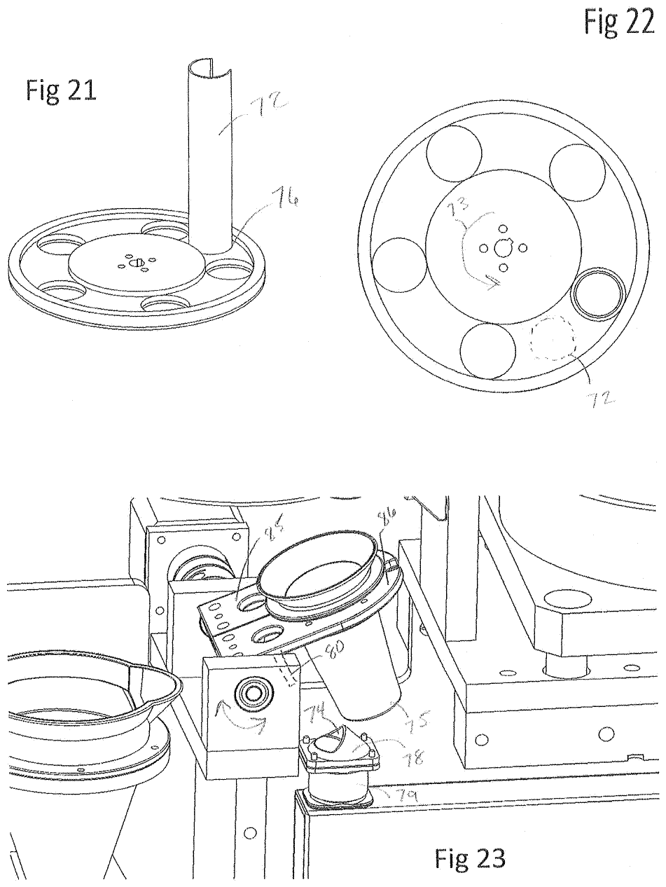

FIG. 21 72 is the accumulation tube and 76 is the rotating on/off valve.

FIG. 22 is a top view of FIG. 21 72 is the off position.

FIG. 23 is a perspective view of a weighing station the weigh cup 75 is rotating into position to rest on a pointed weigh post 78 with a cutout 74 to allow the cup to rest on the point without touching the post 78 the split cup housings 85,86 do not touch the cup once in a resting position. The plate 80 is a mechanical stop plate to prevent the cup from crashing into the load cell to damage it if the shaft coupler slips and the stepper loses its home position.

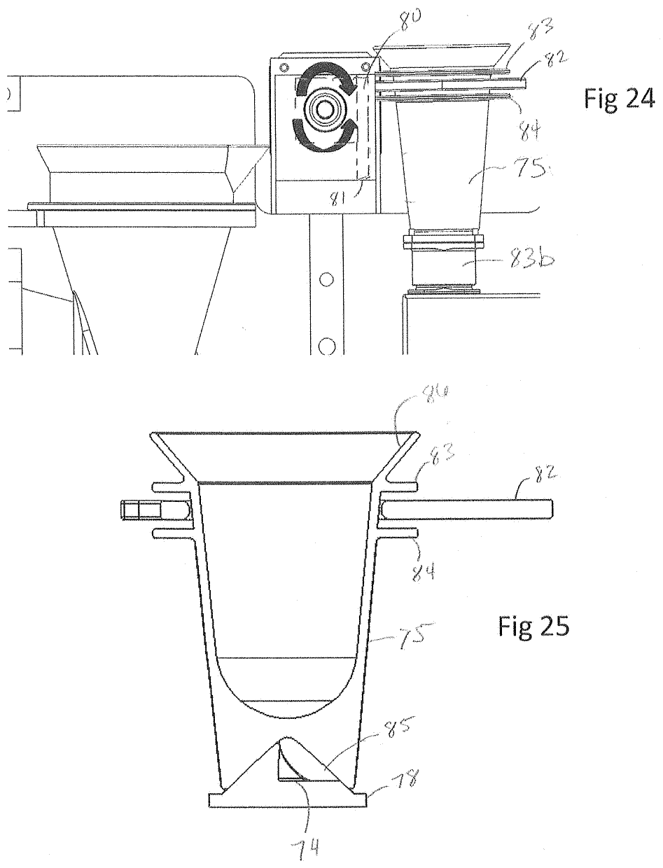

FIG. 24 is a perspective view of the weigh cup 75 and the split mounting brackets 82 the cup 82 a has two flanges 83,84 to hold the cup to the bracket 82. When the weigh cup 75 is sitting on the load cell 83b the bracket 82 is not in contact with the cup 82a.

FIG. 25 is a close up cut-away view of the weigh cup 82a in FIG. 24 sitting on the load cell pointed fixture 79 and the mating convex bottom of the weigh cup 85 to center the cup in the center of the bracket 82 to be contactless so the load cell 83b is only weighing the cup.

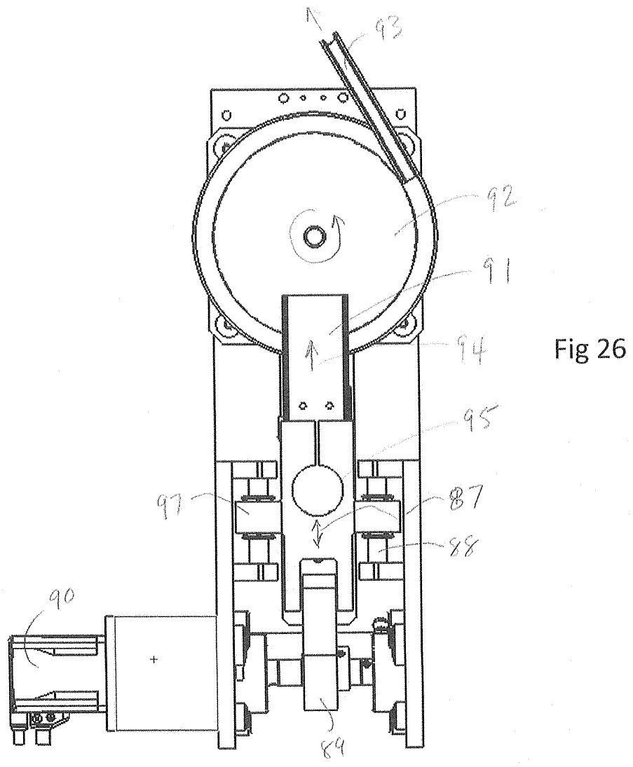

FIG. 26 is a top view of a biomass hopper that shakes in the direction of product to prevent clogging. The biomass is not shown the mounting hole is 95 the linear beading holder is 97, the motor is 90 the eccentric yoke is 89 the feeder to the feeder bowl is 94 and the discharge is 93.

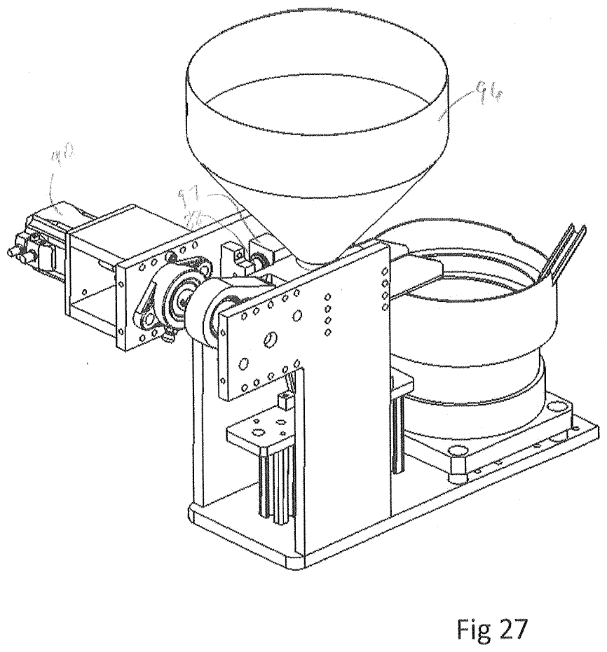

FIG. 27 is a perspective view of a biomass powder feeder, 96 is the storage bowl 97 not shown in FIG. 26. The shaft 88 and linear bearings housing 97 and 90 is the motor.

FIG. 28 Is a perspective view of a frictionless cannabis cone 98 shaker utilizing permanent magnetic suspended on 3 or more electromagnetic coils 100,101,102,103 the pulse in synchronization to pulse the permanent floating magnetic up and down, The outside RF coil 99 that is in synchronization with the electromagnetic suspension coils to shake the cannabis, hemp or other powders in a up and down motion to compact an article without mechanical wear.

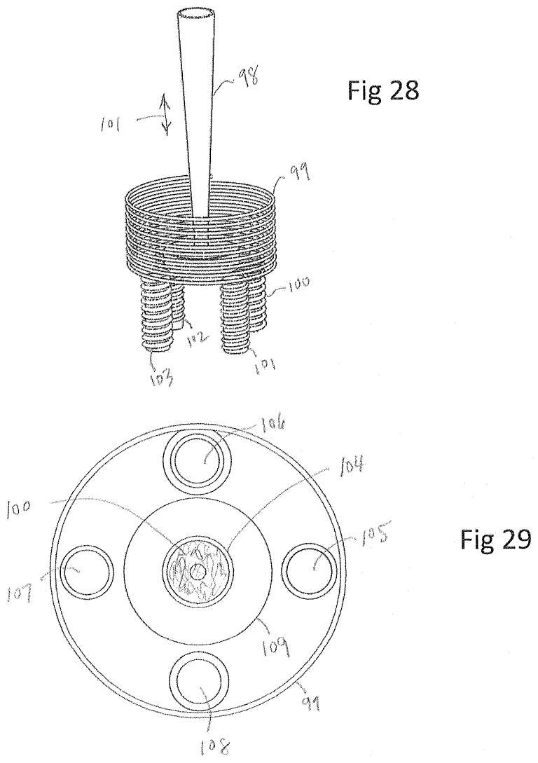

FIG. 29 is a top view of FIG. 29 the power of cannabis is 100 the is being vibrated by digital pulsed electromagnetic coils to settle the powder cannabis into compaction.

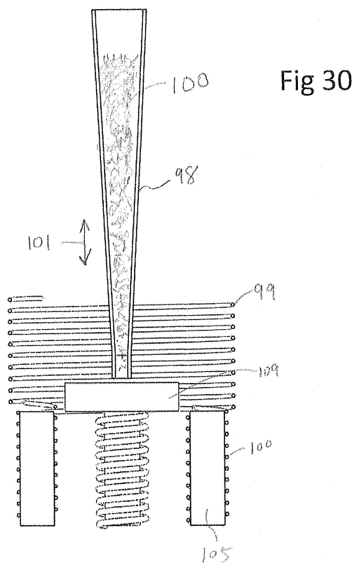

FIG. 30 Is a cutaway view of FIG. 28 the electromagnetic lev

1. Apparatus comprising weighing station that vibrates a powder or ground biomass of flower from cannabis, hemp, tobacco and other biomasses with or without additional plant based oils added into a tapered smokable cone with a programmable linear vibrator to pack the density of the cone during filling of the cone using a linear vibrating funnel with a interface tube and interface vibrating zone to make an accurate smokable cone of an blunt at a precise weight, compactness density and twist, wherein the eccentric vibrations are achieved by a linear slide bearings and eccentric bushing and yoke to deliver precise 2 dimensions vibrations on the biomass storage to prevent rat holing, funnel to deliver powder to the cone and the cone to compact the desired density of the smokable blunt, and wherein the compaction is 2D electromechanical motorized vibration using programmable speeds or electromagnetic digital or analog pulse synchronization with the levitation electromagnetics to move the permanent magnetic up and down at a programmable computer-controlled frequencies.

2. Apparatus as claimed in claim 1, wherein a rotary accumulation valve is used to accumulate a large percentage of weight during the from a vibrator bowl feeder while the precise previous weight was measured and wherein as the rotary valve opens the vibrator feeder delivers directly to the load cell a precise dribble of powder to the desired weight.

3. Apparatus as claimed in claim 1, wherein a additional vibration station will compact the desired compactness density using a programmable motor as the rotation of the motor speed up so will the vibrating frequencies as a linear piston strikes the bottom of the cone filter is a split cone holder that is mounted on a rotating turret Each and wherein each cone is individually vibrated for precise compactness that is controlled by programmable software on a display menu.

4. Apparatus as claimed in claim 1, wherein a frictionless electromagnetic levitation vibrator that suspends a permanent magnetic that bounces a cone filled with cannabis or other loose powders to compact the article using digital or analog electromagnetic pulses to vibrate the cone filled with cannabis or powders at any frequencies that are resident to the compaction frequency of the article.

5. Apparatus as claimed in claim 4, in which the magnetic levitator utilized an outside radio frequency voice coil in electromagnetic digital or analog pulse synchronization with the levitation electromagnetics to move the permanent magnetic up and down at a programmable computer-controlled frequencies.

6. Apparatus as claimed in claim 4, in which the magnetic levitator can vibrate a funnel, conveyor system to move an article without mechanical touching a shaft and bearing connected to an electric motor or connecting rod.

7. Apparatus as claimed in claim 1, which can vibrate product in bottles, cones, bags or conveyor system.

8. Apparatus as claimed in claim 1, which can produce a blunt of cannabis from a pre-roll paper or a continuous roll of paper on the fly.

9. Apparatus as claimed in claim 1, in which cone loading can be made from a rotating stack or linear stack.
